(19) United States
(12) Patent Application Publication
(10) Pub. No.: US 2009/0091679 A1
(43) Pub. Date: Apr. 9, 2009

(54) LIQUID CRYSTAL DISPLAY

(75) Inventors: Young-joo PARK, Hwaseong-si (KR); Jin-Oh Kwag, Suwon-si (KR)

Correspondence Address: CANTOR COLBURN, LLP, 20 Church Street, 22nd Floor, Hartford, CT, 06103, US

(73) Assignee: Samsung Electronics Co., Ltd., Suwon-si (KR)

(21) Appl. No.: 12/243,710

(22) Filed: Oct. 1, 2008

(30) Foreign Application Priority Data
Oct. 8, 2007 (KR) 10-2007-0100990

(51) Int. Cl. G02F 1/1335; G02F 1/133

(52) U.S. Cl. 349/48; 349/114; 349/119

(57) ABSTRACT

A liquid crystal display (“LCD”) includes: a liquid crystal panel having a reflective region in which a first image is displayed in a first viewing direction and a transmissive region in which a second image is displayed in a second different viewing direction; a first optical film assembly disposed on a first surface of the liquid crystal panel and including a first phase-difference film which has a first phase difference, and a first polarizing film; a second optical film assembly disposed on a second opposite surface of the liquid crystal panel and including a second phase-difference film which has a second phase difference, and a second polarizing film; and a phase-difference compensating film disposed on at least one of the first polarizing film and the second polarizing film. The phase-difference compensating film circularly or elliptically polarizes light.

This application claims priority to Korean Patent Application No. 10-2007-0100990, filed on Oct. 8, 2007, and all the benefits accruing therefrom under 35 U.S.C. §119, the contents of which in its entirety are herein incorporated by reference.

### BACKGROUND OF THE INVENTION

1. Field of the Invention

The present invention relates to a display, and more particularly, to a liquid crystal display.

2. Description of the Related Art

A liquid crystal display (“LCD”) typically includes a first display substrate including thin-film transistors (“TFTs”), a second display substrate facing the first display substrate, and a liquid crystal layer including liquid crystal molecules interposed between the first display substrate and the second display substrate. The LCD takes advantage of electrical and optical anisotropy and mobility of the liquid crystal molecules to control transmittance of light by changing the alignment of the liquid crystal molecules using an electrical signal. Specifically, the LCD changes polarization of incident light using birefringence anisotropy of the liquid crystal molecules. To this end, a polarizing film is attached to a top surface of the second display substrate and a bottom surface of the first display substrate of the LCD.

As light emitted from a lamp passes through the LCD, it is linearly polarized by a polarizing film of the LCD such that a desired image is displayed for a user, e.g., a person viewing at the LCD. However, if the user is wearing polarized sunglasses, such as in an outdoor environment, a luminance of the LCD in a specific direction significantly deteriorates. For example, if a polarization axis of the polarizer through which light emitted from the lamp passes is perpendicular to that of the polarized sunglasses, the user wearing the polarized sunglasses cannot view image information displayed by the LCD. Additionally, the polarized sunglasses reduce overall luminance of the LCD except when the polarization axis of the polarizer is substantially parallel to a polarization axis of the polarized sunglasses.

### BRIEF SUMMARY OF THE INVENTION

The present invention has been made in an effort to solve the above stated problems, and an exemplary embodiment of the present invention provides a liquid crystal display (“LCD”), a luminance of which is substantially constant, e.g., is not reduced, when viewed by a user wearing polarized sunglasses.

More specifically, an LCD according to an exemplary embodiment of the present invention includes: a liquid crystal panel having a reflective region in which a first image is displayed in a first viewing direction and a transmissive region in which a second image is displayed in a second different viewing direction; a first optical film assembly disposed on a first surface of the liquid crystal panel and including a first phase-difference film which has a first phase difference, and a first polarizing film; a second optical film assembly disposed on a second opposite surface of the liquid crystal panel and including a second phase-difference film which has a second phase difference, and a second polarizing film; and a phase-difference compensating film disposed on at least one of the first polarizing film and the second polarizing film. The phase-difference compensating film circularly or elliptically polarizes light.

An LCD according to alternative exemplary embodiment of the present invention further includes a first display substrate, a second display substrate facing the first display substrate, and a liquid crystal layer disposed between the first display substrate and the second display substrate. The first display substrate includes a first gate line and a second gate line disposed in a first direction; a data line which crosses the first gate line and the second gate line and is disposed in a second opposite direction, the data line being insulated from the first gate line and the second gate line; a first thin-film transistor formed at an intersection of the first gate line and the data line; a second thin-film transistor formed at an intersection of the second gate line and the data line; a first subpixel electrode connected to the first thin-film transistor and formed in the transmissive region; and a second subpixel electrode connected to the second thin-film transistor and formed in the reflective region.

An LCD according to another alternative exemplary embodiment of the present invention further includes a first display substrate, a second display substrate facing the first display substrate, and a liquid crystal layer disposed between the first display substrate and the second display substrate. The first display substrate includes a gate line disposed in a first direction; a first data line and a second data line which cross the gate line, are disposed in a second opposite direction, and are insulated from the gate line; a first thin-film transistor formed at an intersection of the gate line and the first data line; a second thin-film transistor formed at an intersection of the gate line and the second data line; a first subpixel electrode connected to the first thin-film transistor and formed in the transmissive region; and a second subpixel electrode connected to the second thin-film transistor and formed in the reflective region.

### BRIEF DESCRIPTION OF THE DRAWINGS

The above and other aspects, features and advantages of the present invention will become more readily apparent by describing in further detail exemplary embodiments thereof with reference to the accompanying drawings, in which:

FIG. 1 is an exploded perspective view of a liquid crystal display (“LCD”) according to an exemplary embodiment of the present invention;

FIG. 2 is a partial cross-sectional view of the LCD according to the exemplary embodiment of the present invention shown in FIG. 1;

FIG. 3 is a chart which illustrates variation of a polarized state of light in a transmissive region of the LCD according to the exemplary embodiment of the present invention shown in FIG. 1;

FIG. 4 is a chart which illustrates variation of a polarized state of light in a reflective region of the LCD according to the exemplary embodiment of the present invention shown in FIG. 1;

FIG. 5 is a layout plan view of a first display substrate of the LCD according to the exemplary embodiment of the present invention shown in FIG. 1;

FIG. 6 is a partial cross-sectional view taken along line VI-VI′ of FIG. 5;

FIG. 7 is a partial cross-sectional view of an LCD according to an alternative exemplary embodiment of the present invention; and

FIG. 8 is a partial cross-sectional view of an LCD according to another alternative exemplary embodiment of the present invention.

### DETAILED DESCRIPTION OF THE INVENTION

The invention will now be described more fully hereinafter with reference to the accompanying drawings, in which exemplary embodiments of the invention are shown. The present invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including,” when used in this specification, specify the presence of stated features, regions, integers, steps, operations, elements and/or components, but do not preclude the presence or addition of one or more other features, regions, integers, steps, operations, elements, components and/or groups thereof.

Furthermore, relative terms, such as “lower” or “bottom” and “upper” or “top” may be used herein to describe one element's relationship to other elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on the “upper” side of the other elements. The exemplary term “lower” can, therefore, encompass both an orientation of “lower” and “upper,” depending upon the particular orientation of the figure. Similarly, if the device in one of the figures were turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning which is consistent with their meaning in the context of the relevant art and the present disclosure, and will not be interpreted in an idealized or overly formal sense unless expressly so defined herein.

Exemplary embodiments of the present invention are described herein with reference to cross section illustrations which are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes which result, for example, from manufacturing. For example, a region illustrated or described as flat may, typically, have rough and/or nonlinear features. Moreover, sharp angles which are illustrated may be rounded. Thus, the regions illustrated in the figures are schematic in nature and their shapes are not intended to illustrate the precise shape of a region and are not intended to limit the scope of the present invention.

Hereinafter, exemplary embodiments of the present invention will be explained in further detail with reference to the accompanying drawings.

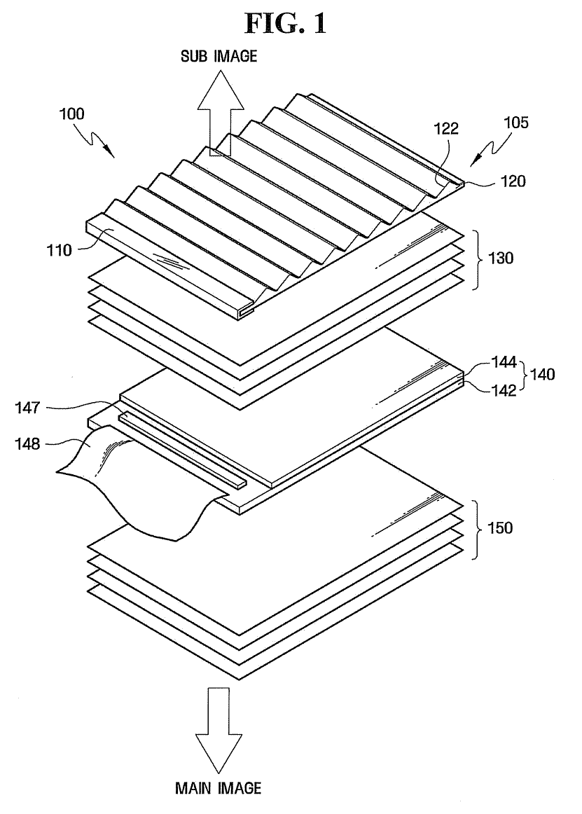

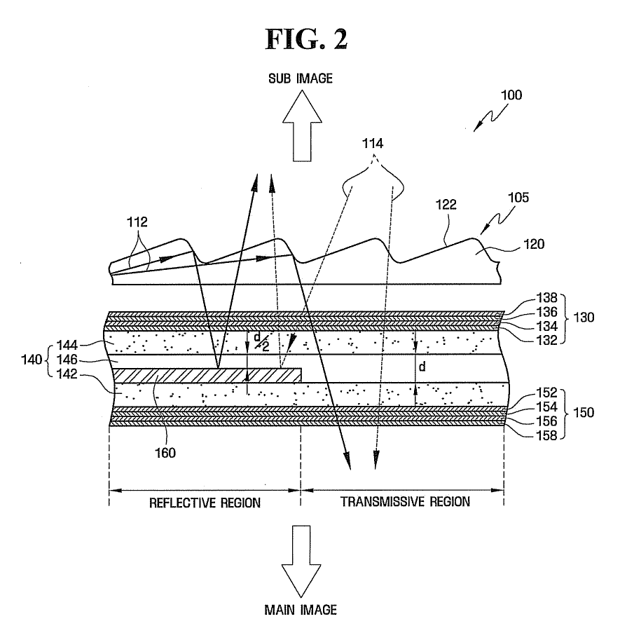

A liquid crystal display (“LCD”) according to an exemplary embodiment of the present invention will now be described in further detail with reference to FIGS. 1 and 2. FIG. 1 is an exploded perspective view of an LCD according to an exemplary embodiment of the present invention. FIG. 2 is a partial cross-sectional view of the LCD according to the exemplary embodiment of the present invention shown in FIG. 1.

The LCD according to exemplary embodiments of the present invention can be used in various devices, including small- and medium-sized displays such as portable multimedia players (“PMPs”), personal digital assistants (“PDAs”), portable digital versatile disk (“DVD”) players, cellular telephones, notebook computers, digital still cameras (“DSCs”) and digital still videos (“DSVs”), as well as medium- and large-sized displays such as digital televisions, for example, but not being limited thereto.

For simplicity of description, exemplary embodiments of the present invention will hereinafter be described with reference to use in a cellular telephone which is used in an outdoor environment having natural light, e.g., sunlight. However, alternative exemplary embodiments of the present invention are not limited thereto. Rather, alternative exemplary embodiments may be used in any of the above-mentioned devices, as well as any other device which requires an LCD.

Referring to FIGS. 1 and 2, an LCD 100 includes a liquid crystal panel 140, a first optical film assembly 130 and a second optical film assembly 150 disposed on opposite sides of the liquid crystal panel 140, and a front light unit 105 disposed on the first optical film assembly 130.

The liquid crystal panel 140 controls transmittance of light which passes through a liquid crystal layer 146 according to an intensity of a voltage applied to the liquid crystal layer 146 and displays image information, such as characters, numbers and icons, for example, thereon. The liquid crystal panel 140 includes a first display substrate 142 having a thin-film transistor (“TFT”) array (not shown), a second display substrate 144 substantially facing the first display substrate 142. The liquid crystal layer 146 is interposed substantially between the first display substrate 142 and the second display substrate 144 and includes liquid crystal molecules.

The first display substrate 142 includes a plurality of gate lines, a plurality of data lines, and a pixel electrode (none shown). The gate lines extend in a first direction, e.g., a substantially horizontal or row direction, on the first display substrate 142 and transmit gate signals, while the data lines extend in a second opposite direction, e.g., a substantially vertical or column direction, on the first display substrate 142 and transmit data signals. In an exemplary embodiment, the pixel electrode is made of a transparent conductive material such as indium tin oxide (“ITO”) or indium zinc oxide (“IZO”), for example, but is not limited thereto.

Switching devices (not shown) are formed at intersections of the gate lines and the data lines. An output terminal of each switching device is connected to a storage capacitor (not shown) and a liquid crystal capacitor (not shown). In addition, each switching device is implemented as a TFT using amorphous silicon (“a-Si”) or polysilicon (“p-Si”) as a channel layer. A terminal of the storage capacitor may be connected to a common voltage.

Referring still to FIGS. 1 and 2, the second display substrate 144 faces the first display substrate 142 and includes red, green and/or blue color filters (not shown) in regions corresponding to the pixel electrode so that each pixel displays a color. The color filters may be disposed on or under the pixel electrode. In addition, a common electrode (not shown) made of a transparent conductive material, such as ITO or IZO, for example, is formed on the color filters.

The liquid crystal layer 146 includes liquid crystal molecules (not shown) disposed between the first display substrate 142 and the second display substrate 144. A direction in which the liquid crystal molecules are arranged is determined by a voltage applied, from an external source (not shown), to the liquid crystal layer 146. Therefore, transmittance of light which passes through the liquid crystal layer 146 is adjusted according to the direction in which the liquid crystal molecules are arranged. In an exemplary embodiment, the liquid crystal molecules in the liquid crystal layer 146 are arranged in a vertical alignment (“VA”) mode, but alternative exemplary embodiments are not limited thereto. For example, the liquid crystal molecules may be arranged in a twisted nematic (“TN”) mode, a reverse TN mode, a mixed TN mode, a homogeneous alignment mode, or a reverse electrically controlled birefringence (“ECB”) mode.

The pixel electrode of the first display substrate 142, the common electrode of the second display substrate 144, and the liquid crystal layer 146 form the liquid crystal capacitor.

The liquid crystal panel 140 included in the LCD 100 according to an exemplary embodiment is semi-transmissive. For example, the liquid crystal panel 140 may be divided into a reflective region and a transmissive region. More specifically, the reflective region is a region wherein a reflector 160 (FIG. 2) is disposed between the first display substrate 142 and the second display substrate 144. In the reflective region, lamp light 112 from a lamp 110 and external light 114 are reflected substantially upward (as viewed in FIGS. 1 and 2) by the reflector 160 to form a sub image SUB IMAGE. Conversely, the transmissive region is a region not including the reflector 160. Thus, the lamp light 112 and the external light 114 pass downward through the transmissive region of the liquid crystal panel 140 and form a main image MAIN IMAGE.

A driving integrated circuit (“IC”) 147 receives a gate control signal, a data control signal, and a data signal from a printed circuit board (“PCB”) (not shown) via an input terminal thereof and transmits a gate driving signal and a data driving signal to the gate lines and the data lines, respectively, formed on the first display substrate 142 via an output terminal thereof. Therefore, a desired image is displayed on the liquid crystal panel 140.

As shown in FIG. 1, in an exemplary embodiment, the driving IC 147 is mounted on a peripheral region of the first display substrate 142, e.g., not in an image display region which corresponds to the second display substrate 144. Further, the driving IC 147 is mounted on the peripheral region of the first display substrate 142 using a chip on glass (“COG”) method so that the output terminal of the driving IC 147 is connected to the gate lines and the data lines extending toward the driving IC 147 from the image display region. As described in further detail above, the gate driving signal and the data driving signal generated by the driving IC 147 are transmitted to each pixel in the image display region of the first display substrate 142.

A flexible PCB (“FPCB”) 148 including electric wiring formed on a flexible board according to a predetermined circuit design connects and/or supports various electronic parts (not shown). The FPCB 148 includes a base film, terminal regions, and an interface region. A plurality of thin metal-sheet patterns, e.g., lead terminals (not shown), are arranged in the terminal regions on both sides of the base film. Additional thin metal-sheet patterns, e.g., the electric wiring, are formed in the interface region and connect the terminal regions arranged on both sides of the base film to each other. A plurality of through-holes (not shown) may be formed in the interface region, and electronic parts mounted on the base film may be connected to the electric wiring by the through-holes to form an electric circuit.

An end of the FPCB 148 formed as described above is connected to the PCB (not shown), and an opposite end thereof is connected to the input terminal of the driving IC 147. Therefore, the FPCB 148 delivers the gate driving signal, the data driving signal and the data signal from the PCB to the driving IC 147.

The front light unit 105 is disposed adjacent to the second display substrate 144 of the liquid crystal panel 140 and supplies light to the liquid crystal panel 140. The front light unit 105 includes a light guide panel 120 and the lamp 110.

The light guide panel 120 guides light emitted from the lamp 110. In an exemplary embodiment, the light guide panel 120 is made of a transparent plastic material such as acrylic, for example, and guides light emitted from the lamp 110 toward the liquid crystal panel 140 disposed under the light guide panel 120. Therefore, various patterns may be formed on a top surface of the light guide panel 120 to guide light incident to the light guide panel 120 toward the liquid crystal panel 140. A prism pattern 122 is formed on the top surface of the light guide panel 120. In an alternative exemplary embodiment of the present invention, the top surface of the light guide panel 120 is substantially flat (not shown in FIGS. 1 and 2) and the prism pattern 122 is formed on a bottom surface of the light guide panel 122.

In order to increase a display quality of the sub image SUB IMAGE formed in the reflective region of the LCD 100, a reflective layer (not shown) may be formed on a portion of the top surface of the light guide panel 120 which overlaps the transmissive region. Specifically, the reflective layer is formed on the portion of the top surface of the light guide panel 120 which overlaps the transmissive region to block external light received through the transmissive region from under the liquid crystal panel 140, since the external light may decrease the display quality of the sub image SUB IMAGE formed by the reflective region.

As shown in FIG. 1., the lamp 110 is disposed at a peripheral end of the light guide panel 120 to provide light to a side of the light guide panel 120. In an exemplary embodiment, the lamp 110 is a light emitted diode (“LED”), but in alternative exemplary embodiments, the lamp 110 may be a cold cathode fluorescent lamp (“CCFL”) or an external electrode fluorescent lamp (“EEFL”), for example, but is not limited thereto.

Still referring to FIG. 2, the first optical film assembly 130 is interposed between the liquid crystal panel 140 and the front light unit 105. The first optical film assembly 130 includes a first λ/4 phase-difference film 132, a first λ/2 phase-difference film 134, a first polarizing film 136, and a first phase-difference compensating film 138 on an upper surface of the liquid crystal panel 140.

The first λ/4 phase-difference film 132 is disposed on the second display substrate 144 and has a phase difference of λ/4. For example, the first λ/4 phase-difference film 132 may have a delay value of approximately 120 nm to approximately 180 nm with respect to light having a wavelength of approximately 550 nm, thereby introducing the phase difference of approximately λ/4 such that light which exits the first λ/4 phase-difference film has a wavelength of approximately 370 nm to approximately 430 nm.

The first λ/2 phase-difference film 134 is disposed on the first λ/4 phase-difference film 132 and has a phase difference, with respect to light having a wavelength of λ, of approximately λ/2. For example, the first λ/2 phase-difference film 134 may have a delay value of approximately 240 nm to approximately 320 nm with respect to light having a wavelength of approximately 550 nm, thereby introducing the phase difference of approximately λ/2, e.g., light exiting the first λ/2 phase-difference film has a wavelength of approximately 230 nm to approximately 310 nm.

In an alternative exemplary embodiment, the first λ/2 phase-difference film 134 maybe excluded from the first optical film assembly 130.

The first polarizing film 136 is disposed on the first λ/2 phase-difference film 134 and polarizes light which passes therethrough. More specifically, light substantially perpendicular to a polarization axis of the first polarizing film 136 cannot pass through, e.g., is effectively blocked by, the first polarizing film 136.

In an exemplary embodiment, the first polarizing film 136 is made of polyvinyl alcohol (“PVA”), polycarbonate, polystyrene, or polymethacrylate, for example. A support film (not shown) may be adhered to a surface of the first polarizing film 136 to enhance durability, mechanical strength, thermal resistance, and moisture resistance of the first polarizing film 136. The support films may be made of triacetyl celluous (“TAC”), polyethylene terephthalate, polyethylene glycol, polymethyl metacrylate, or polycarbonate, for example, but alternative exemplary embodiments of the present invention are not limited thereto.

The first phase-difference compensating film 138 is disposed on the first polarizing film 136 and circularly or elliptically polarizes light which has been linearly polarized by the first polarizing film 136. In an exemplary embodiment, the first phase-difference compensating film 138 is be a λ/4 phase-difference film, e.g., the first phase-difference compensating film 138 delays the phase of light by λ/4, as described above in greater detail. Therefore, in the LCD 100 according to an exemplary embodiment of the present invention, a sharp drop in the luminance of the LCD 100 in a specific viewing direction is be prevented, and a user can see the sub image SUB IMAGE formed by the circularly or elliptically polarized light, even if the user is wearing polarized sunglasses which would otherwise prevent the user from viewing the subimage SUB IMAGE.

The second optical film assembly 150 is disposed under the liquid crystal panel 140 in a substantially symmetrical manner with respect to the first optical film assembly 130. The second optical film assembly 150 includes a second λ/4 phase-difference film 152, a second λ/2 phase-difference film 154, a second polarizing film 156, and a second phase-difference compensating film 158 disposed on a lower surface of the liquid crystal panel 140.

Still referring to FIGS. 1 and 2, the second λ/4 phase-difference film 152 is disposed under the first display substrate 142 and has a phase difference of approximately λ/4. For example, in an exemplary embodiment, the second λ/4 phase-difference film 152 has a delay value of approximately 120 nm to approximately 180 nm with respect to light having a wavelength of approximately 550 nm.

The second λ/2 phase-difference film 154 is disposed under the second λ/4 phase-difference film 152 and has a phase difference of λ/2. For example, in an exemplary embodiment of the present invention, the second λ/2 phase-difference film 154 has a delay value of approximately 240 nm to approximately 320 nm with respect to light having a wavelength of approximately 550 nm.

In an alternative exemplary embodiment, the second λ/2 phase-difference film 154 may be excluded from the second optical film assembly 150.

The second polarizing film 156 is disposed under the second λ/2 phase-difference film 154 and polarizes light which passes therethrough. Specifically, light substantially perpendicular to a polarization axis of the second polarizing film 156 cannot pass through, e.g., is effectively blocked by, the second polarizing film 156. In an exemplary embodiment, the second polarizing film 156 is made of PVA, polycarbonate, polystyrene, or polymethacrylate, for example. A support film (not shown) may be adhered to a surface of the second polarizing film 156 to enhance the durability, mechanical strength, thermal resistance, and moisture resistance of the second polarizing film 156. The support films may be made of TAC, polyethylene terephthalate, polyethylene glycol, polymethyl metacrylate, or polycarbonate.

The second phase-difference compensating film 158 is disposed under the second polarizing film 156 and circularly or elliptically polarizes light which has been linearly polarized by the second polarizing film 156. The second phase-difference compensating film 158 may be a λ/4 phase-difference film which delays the phase of light by λ/4. Thus, a sharp drop in the luminance of the LCD 100 in a specific direction is substantially reduced and/or effectively prevented, and a user can see the main image MAIN IMAGE formed y the circularly or elliptically polarized light even when the user is wearing polarized sunglasses.

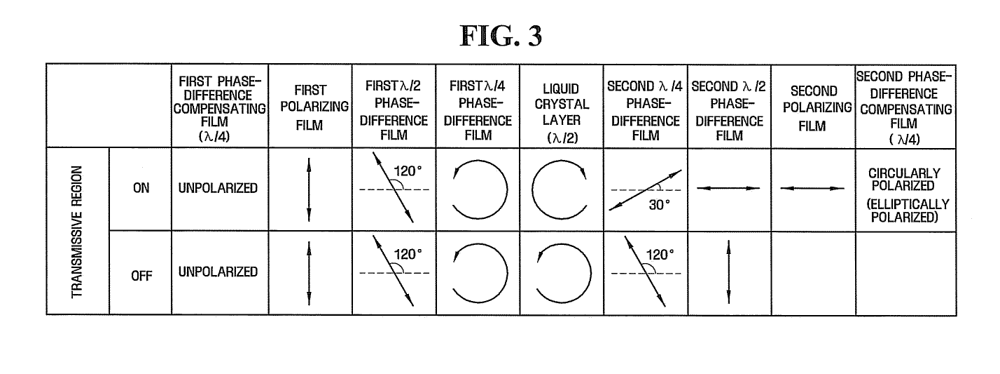

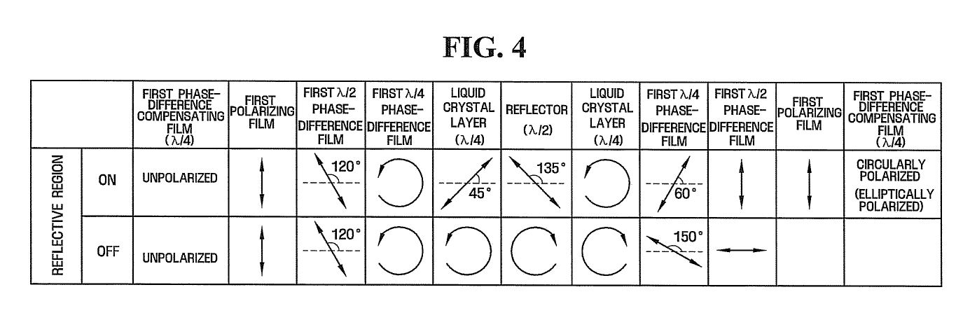

Relationships between the phase-difference films, the polarizing films and the phase-difference compensating films described in greater detail above will now be described in further detail with reference to FIGS. 2 through 4. More specifically, a process of forming the subimage SUB IMAGE and the main image MAIN IMAGE (FIGS. 1 and 2) by polarizing light emitted from the front light unit 105 using the relationships between optic, e.g., optical, axes of the phase-difference films, optic axes of the phase-difference compensating films and polarization axes of the polarizing films will be described in further detail. FIG. 3 is a chart which illustrates variation in a polarized state of light in the transmissive region of the LCD according to the exemplary embodiment of the present invention shown in FIG. 1. FIG. 4 is a chart which illustrates variation in a polarized state of light in the reflective region of the LCD according to the exemplary embodiment of the present invention shown in FIG. 1. For purposes of description, it will hereinafter be assumed that an angle at a “three o'clock” position, e.g., pointing substantially to the right in FIGS. 3 and 4, from a point of view of an observer is 0 degrees and that rotation in a clockwise direction is a forward direction. In addition, a VA mode LCD will be described. More specifically, in the LCD 100 having the VA mode, a long axis of the liquid crystal molecules is perpendicular to surfaces of the first display substrate 142 and the second display substrate 144 (FIGS. 1 and 2) when no electric field is applied to the liquid crystal layer 146 (FIG. 2). Thus, since the polarization axis of the first polarizing film 136 is substantially perpendicular to the polarization axis of the second polarizing film 156, the LCD 100 operates in a normally black mode, e.g., the LCD 100 displays a black screen when no electric field is applied to the liquid crystal layer 146.

In addition, for purposes of illustration and description, an exemplary embodiment will hereinafter be described based on an assumptions that: the polarization axis of the first polarizing film 136 is approximately 90 degrees; the optic axis of the first λ/2 phase-difference film 134 is approximately 105 degrees; the optic axis of the first λ/4 phase-difference film 132 is approximately 165 degrees; the optic axis of the second λ/4 phase-difference film 152 is approximately 75 degrees; the optic axis of the second λ/2 phase-difference film 154 is approximately 15 degrees; and the polarization axis of the second polarizing film 156 is approximately 0 degrees.

The distance between the first display substrate 142 and the second display substrate 144, e.g., a thickness of the liquid crystal layer 146, is defined as a cell gap. The cell gap and a refractive index of liquid crystal molecules are adjusted such that the liquid crystal layer 146 has a phase difference of λ/2 in the transmissive region and the liquid crystal layer 146 has a phase difference of λ/4 in the reflective region when no electric field is applied to the liquid crystal layer 146. For example, the cell gap in the transmissive region may be substantially equal to a value d (FIG. 2), and the cell gap in the reflective region may be substantially equal to d/2. In addition, an exemplary embodiment will hereinafter be described based on assumptions that an alignment direction of the liquid crystal molecules of the liquid crystal layer 146 is approximately 0 degrees, e.g., when no electric field is applied to the liquid crystal layer 146, the alignment direction of the liquid crystal molecules is perpendicular to the first display substrate 142 and the second display substrate 144. Thus, no phase difference occurs when no electric field is applied to the liquid crystal layer 146.

Referring to FIGS. 2 and 3, when an electric field (not shown) is applied to the liquid crystal layer 146 in the transmissive region (hereinafter referred to as an “ON” state), unpolarized light, e.g., the external light 114 or the lamp light 112, remains unpolarized after passing through the first phase-difference compensating film 138. As the unpolarized external light 114 or lamp light 112 passes through the first polarizing film 136, it is linearly polarized at approximately 90 degrees. Then, the light linearly polarized at approximately 90 degrees passes through the first λ/2 phase-difference film 134 and is thereby linearly polarized at approximately 120 degrees. As the light linearly polarized at approximately 120 degrees passes through the first λ/4 phase-difference film 132, it is circularly polarized to the left, as indicated by the arrow in FIG. 3. In addition, as the light circularly polarized to the left passes through the liquid crystal layer 146, it is circularly polarized to the right. Then, the light circularly polarized to the right passes through the second λ/4 phase-difference film 152 and is linearly polarized at approximately 30 degrees. The light linearly polarized at approximately 30 degrees next passes through the second λ/2 phase-difference film 154 and is linearly polarized at approximately 0 degrees to match a transmission axis of the second polarizing film 156.

As the light linearly polarized at 0 degrees passes through the second polarizing film 156 and the second phase-difference compensating film 158, it is circularly or elliptically polarized. In an exemplary embodiment, an angle between the optic axis of the second phase-difference compensating film 158 and the polarization axis of the second polarizing film 156 is approximately 45 degrees, and circularly polarized light is output; however, alternative exemplary embodiments of the present invention are not limited thereto. For example, when the angle between the optic axis of the second phase-difference compensating film 158 and the polarization axis of the second polarizing film 156 is not equal to approximately 45 degrees, elliptically polarized light, e.g., non-circularly polarized light, is outputted, as shown in FIG. 3. Therefore, a user can see the main image MAIN IMAGE (FIG. 2) formed by the circularly or, alternatively, elliptically polarized light even when the user is wearing polarized sunglasses. Further, as discussed above in greater detail, a sharp drop in the luminance of the LCD 100 in a specific direction is substantially reduced or effectively prevented in the LCD 100 according to an exemplary embodiment of the present invention.

Still referring to FIGS. 2 and 3, when no electric field is applied to the liquid crystal layer 146 in the transmissive region (hereinafter referred to as an “OFF” state), unpolarized light, e.g., the external light 114 or the lamp light 112 remains unpolarized after passing through the first phase-difference compensating film 138. As the unpolarized external light 114 or lamp light 112 passes through the first polarizing film 136, it is linearly polarized at approximately 90 degrees. Then, the light linearly polarized at approximately 90 degrees passes through the first λ/2 phase-difference film 134 and is linearly polarized at approximately 120 degrees. As the light linearly polarized at approximately 120 degrees passes through the first λ/4 phase-difference film 132, it is circularly polarized to the left.

When the light circularly polarized to the left passes through the liquid crystal layer 146, no phase shift occurs. Thus, the light circularly polarized to the left remains circularly polarized to the left after passing through the liquid crystal layer 146. As the light circularly polarized to the left passes through the second λ/4 phase-difference film 152, however, it is linearly polarized at approximately 120 degrees. In addition, as the light linearly polarized at 120 degrees passes through the second λ/2 phase-difference film 154, it is linearly polarized at approximately 90 degrees to be substantially perpendicular to the transmission axis of the second polarizing film 156. Since the light linearly polarized at 90 degrees cannot pass through the second polarizing film 156, a black screen is displayed on the liquid crystal panel 140.

Referring now to FIGS. 2 and 4, when an electric field is applied to the liquid crystal layer 146 in the reflective region, e.g., the ON state, unpolarized light, e.g., the external light 114 or the lamp light 112, remains unpolarized after passing through the first phase-difference compensating film 138. As the unpolarized external light 114 or lamp light 112 passes through the first polarizing film 136, it is linearly polarized at approximately 90 degrees. Then, the light linearly polarized at approximately 90 degrees passes through the first λ/2 phase-difference film 134 and is linearly polarized at approximately 120 degrees. As the light linearly polarized at approximately 120 degrees passes through the first λ/4 phase-difference film 132, it is circularly polarized to the left. As the light circularly polarized to the left passes through the liquid crystal layer 146, it is linearly polarized at approximately 45 degrees.

As the light linearly polarized at approximately 45 degrees is reflected by the reflector 160, it is linearly polarized at approximately 135 degrees. Then, the light linearly polarized at approximately 135 degrees passes again through the liquid crystal layer 146 and is circularly polarized to the left. Then, the light circularly polarized to the left passes through the first λ/4 phase-difference film 132 and is linearly polarized at approximately 60 degrees. As the light linearly polarized at approximately 60 degrees passes through the first λ/2 phase-difference film 134, it is linearly polarized at approximately 90 degrees to substantially match a transmission axis of the first polarizing film 136.

As the light linearly polarized at approximately 90 degrees passes through the first polarizing film 136 and the first phase-difference compensating film 138, it is circularly or elliptically polarized. Specifically, when an angle between the optic axis of the first phase-difference compensating film 138 and the polarization axis of the first polarizing film 136 is approximately 45 degrees, circularly polarized light is output. Alternatively, when the angle between the optic axis of the first phase-difference compensating film 138 and the polarization axis of the first polarizing film 136 is not equal to approximately 45 degrees, elliptically polarized light is output, as shown in FIG. 4. Therefore, a sharp drop in the luminance of the LCD 100 in a specific direction is substantially reduced and/or effectively prevented, and a user can see the sub image SUB IMAGE formed by the circularly or elliptically polarized light even when the user is wearing polarized sunglasses.

Still referring to FIG. 4, when an electric field is not applied to the liquid crystal layer 146 in the reflective region, e.g., the OFF state, unpolarized light, e.g., the external light 114 or the lamp light 112 remains unpolarized after passing through the first phase-difference compensating film 138. As the unpolarized external light 114 or lamp light 112 passes through the first polarizing film 136, it is linearly polarized at approximately 90 degrees. Then, the light linearly polarized at approximately 90 degrees passes through the first λ/2 phase-difference film 134 and is linearly polarized at approximately 120 degrees. As the light linearly polarized at 120 degrees passes through the first λ/4 phase-difference film 132, it is circularly polarized to the left.

When the light circularly polarized to the left passes through the liquid crystal layer 146, no phase difference occurs. Thus, the light circularly polarized to the left remains circularly polarized to the left after passing through the liquid crystal layer 146. As the light circularly polarized to the left is reflected by the reflector 160, it is circularly polarized to the right. When the light circularly polarized to the right passes through the liquid crystal layer 146 again, it remains circularly polarized to the right. As the light circularly polarized to the right passes through the first λ/4 phase-difference film 132, it is linearly polarized at approximately 150 degrees. As the light linearly polarized at approximately 150 degrees passes through the first λ/2 phase-difference film 134, it is linearly polarized at approximately 0 degrees to be substantially perpendicular to the transmission axis of the first polarizing film 136. Since the light linearly polarized at approximately 0 degrees cannot pass through the first polarizing film 136, a black screen is displayed on the liquid crystal panel 140.

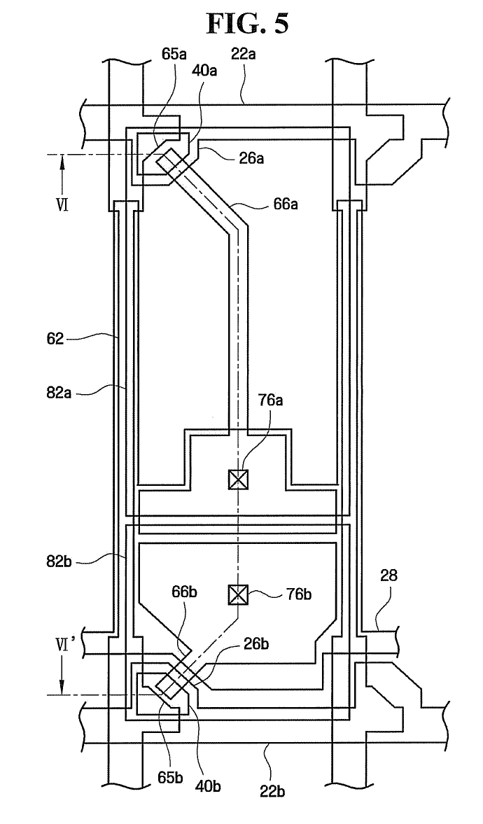

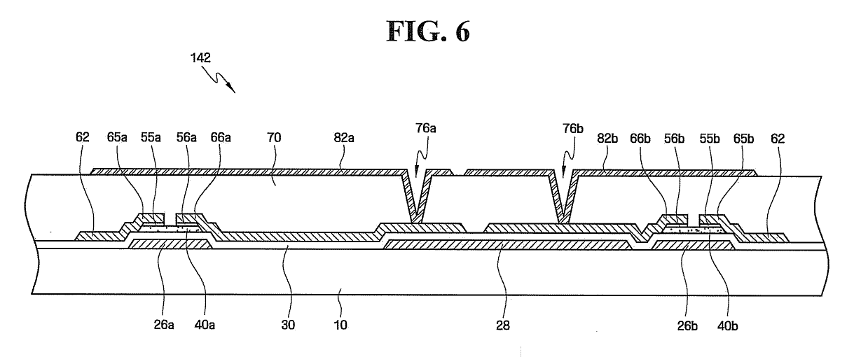

The first display substrate 142 included in the LCD 100 according to an exemplary embodiment of the present invention will now be described in further detail with reference to FIGS. 5 and 6. FIG. 5 is a layout plan view of a first display substrate, e.g., the first display substrate 142 of the LCD according to the exemplary embodiment of the present invention shown in FIG. 1. FIG. 6 is a partial cross-sectional view taken along line VI-VI′ of FIG. 5.

Referring to FIGS. 5 and 6, a first gate line 22a and a second gate line 22b, as well as a storage wire 28 are formed on an insulation substrate 10 which is made of a material such as transparent glass, for example.

The first gate line 22a and the second gate line 22b extend in the first, e.g., substantially horizontal direction, and are physically and electrically separated from each other. The first gate line 22a and the second gate line 22b transmit gate signals. Further, the first gate line 22a and the second gate line 22b are disposed in an upper portion and a lower portion, respectively, of each pixel, as shown in FIG. 5. In addition, a first gate electrode 26a branches downward from the first gate line 22a, and a second gate electrode 26b branches upward from the second gate line 22b. The first gate line 22a, the second gate line 22b, the first gate electrode 26a, and the second gate electrode 26b will hereinafter be collectively referred to as “gate wiring”.

The storage wire 28 extends in the first, e.g., substantially horizontal, direction and carries a common voltage. The storage wire 28 overlaps a first drain electrode 66a and a second drain electrode 66b to form storage capacitors.

In an exemplary embodiment, the gate wiring and the storage wire 28 are made of an aluminum (Al)-based metal, such as Al or an Al alloy, a silver (Ag)-based metal, such as Ag or an Ag alloy, a copper (Cu)-based metal such as Cu or a Cu alloy, a molybdenum (Mo)-based metal such as Mo or a Mo alloy, chrome (Cr), titanium (Ti), or tantalum (Ta), for example, but alternative exemplary embodiments are not limited thereto. In addition, the gate wiring and the storage wire 28 may have a multi-layered structure including two conductive layers (not shown) with different physical characteristics. One of the two conductive layers may be made of a metal with low resistivity, such as an Al-based metal, an Ag-based metal or a Cu-based metal, in order to reduce a signal delay or a voltage drop of the gate wiring and the storage wire 28. Conversely, the other one of the conductive layers may be made of a different material, such as a material having superior contact characteristics with ITO and IZO, such as a Mo-based metal, chrome, titanium, or tantalum, for example. In addition, the multi-layered structure may be a double-layered structure including a combination of a lower chrome layer and an upper Al layer or a combination of a lower Al layer and an upper Mo layer. However, alternative exemplary embodiments of the present invention are not limited to the abovementioned structures; rather, the gate wiring and the storage wire 28 of alternative exemplary embodiments may be formed of various metals and conductors.

A gate insulating film 30, made of silicon nitride (“SiNx”), for example, is formed on the gate wiring, e.g., on the first gate line 22a and the second gate line 22b, as well as the first storage electrode 26a, the second storage electrode 26b, and the storage wiring 28.

Semiconductor layers 40a and 40b, made of hydrogenated amorphous silicon or polycrystalline silicon, for example, are formed on the gate insulating film 30. The semiconductor layers 40a and 40b may have various shapes. For example, in an exemplary embodiment, the semiconductor layers 40a and 40b may be shaped substantially like islands, as shown in FIG. 5. However, in an alternative exemplary embodiment, the semiconductor layers 40a and 40b may be substantially rectilinear, and may extend along a data line 62.

Ohmic contact layers 55a, 55b, 56a and 56b are formed on the semiconductor layers 40a and 40b. In an exemplary embodiment, the ohmic contact layers 55a, 55b, 56a and 56b are made of a material such as silicide or n+ hydrogenated amorphous silicon doped with n-type impurities in high concentration, for example. A first pair of the ohmic contact layers 55a and 56a and a second pair of the ohmic contact layers 55b and 56b are disposed on the semiconductor layers 40a and 40b, respectively.

The data line 62, the first drain electrode 66a, and the second drain electrode 66b are formed on the ohmic contact layers 55a, 55b, 56a and 56b and the gate insulating film 30, as shown in FIG. 6.

The data line 62 extends in the second, e.g., substantially vertical, direction and crosses the first gate line 22a and the second gate line 22b, and delivers a data voltage. The data line 62 has a first source electrode 65a and a second source electrode 65b each of which extends substantially toward the first drain electrode 66a and the second drain electrode 66b, respectively. The data line 62, the first source electrode 65a, the second source electrode 65b, the first drain electrode 66a, and the second drain electrode 66b will hereinafter collectively be referred to as “data wiring”.

In an exemplary embodiment, the data wiring is made of chrome, a Mo-based metal, or a refractory metal such as tantalum and titanium, for example. In addition, the data wiring may have a multi-layered structure including a lower layer (not shown) made of a refractory metal, and an upper layer (not shown) made of a material having a low resistivity and disposed on the lower layer. The multi-layered structure may be a double-layered structure including a combination of a lower chrome layer and an upper Al layer or, alternatively, a combination of a lower Al layer and an upper Mo layer. In an alternative exemplary embodiment, the multi-layered structure may be a triple-layered structure composed of Mo, Al, and Mo layers, for example, but not being limited thereto.

The first source electrode 65a and the second source electrode 65b partially overlap the semiconductor layers 40a and 40b, respectively. In addition, the first drain electrode 66a and the second drain electrode 66b face the first source electrode 66a and the second source electrode 66b with respect to the first gate electrode 26a and the second gate electrode 26b, respectively, and partially overlap the semiconductor layers 40a and 40b, respectively, as shown in FIGS. 5 and 6. In an exemplary embodiment, the ohmic contact layers 55a, 55b, 56a and 56b are interposed between the semiconductor layers 40a and 40b, the first source electrode 65a and the second source electrode 65b, the semiconductor layers 40a and 40b, the first drain electrode 66a, and the second drain electrode 66b to reduce contact resistance therebetween.

In an exemplary embodiment, the first drain electrode 66a and the second drain electrode 66b have a substantially bar-shaped portion which overlaps the semiconductor layer 40a or 40b, and a relatively wider extension portion which extends from the bar-shaped portion to overlap the storage wire 28. More specifically, the second drain electrode 66b is formed under a second subpixel electrode 82b which corresponds to the reflective region and functions as the reflector 160 (FIG. 2) which reflects the lamp light 112 (FIG. 2) and the external light 114 (FIG. 2). In an alternative exemplary embodiment, the storage wire 28 disposed under the second drain electrode 66b may also function as the reflector 160. However, alternative exemplary embodiments of the present invention are not limited thereto. For example, the second subpixel electrode 82b may be made of a reflective conductor and thus function as the reflector 160 (FIG. 2).

In an exemplary embodiment, a first TFT is a three-terminal device having the first gate electrode 26a as a control terminal, the first source electrode 65a as an input terminal, and the first drain electrode 66a as an output terminal. In addition, a second TFT is a three-terminal device having the second gate electrode 26b as a control terminal, the second source electrode 65b as an input terminal, and the second drain electrode 66b as an output terminal.

A passivation layer 70 is formed on the data wiring. The passivation layer 70 is made of an inorganic material such as silicon nitride or silicon oxide, an organic material having photosensitivity and superior planarization characteristics, or an insulating material, such as a-Si:C:O or a-Si:O:F formed by plasma enhanced chemical vapor deposition (“PECVD”), for example, but not being limited thereto. The passivation layer 70 may have a double-layered structure including a lower inorganic layer and an upper organic layer to protect exposed portions of the semiconductor layers 40a and 40b while taking advantage of superior characteristics of the organic layer.

A first contact hole 76a and a second contact hole 76b expose the first drain electrode 66a and the second drain electrode 66b, respectively, and are formed in the passivation layer 70. The first subpixel electrode 82a and the second subpixel electrode 82b are formed in each pixel region and are electrically connected to the first drain electrode 66a and the second drain electrode 66b by the first contact hole 76a and the second contact hole 76b, respectively. The first subpixel electrode 82a and the second subpixel electrode 82b are made of reflective conductors such as ITO or IZO, for example, but are not limited thereto.

The first subpixel electrode 82a and the second subpixel electrode 82b are physically and electrically connected to the first drain electrode 66a and the second drain electrode 66b by the first contact hole 76a and the second contact hole 76b, respectively, and receive data voltages from the first drain electrode 66a and the second drain electrode 66b, respectively.

The first subpixel electrode 82a and the second subpixel electrode 82b, to which the data voltages are applied, generate an electric field with the common electrode of the second display substrate 144 to thereby align the liquid crystal molecules of the liquid crystal layer 146 disposed between the first subpixel electrode 82a, the second subpixel electrode 82b, and the common electrode.

The first subpixel electrode 82a and the common electrode form a first liquid crystal capacitor (not shown), while the second subpixel electrode 82b and the common electrode form a second liquid crystal capacitor (not shown). The first liquid crystal capacitor and the second liquid crystal capacitor sustain voltages applied thereto after the first TFT and the second TFT are turned off. To enhance voltage-sustaining capabilities, the first storage capacitor and the second storage capacitor are connected in parallel to the first liquid crystal capacitor and the second liquid crystal capacitor, respectively. The first storage capacitor and the second storage capacitor are formed by overlapping the first subpixel electrode 82a and the second subpixel electrode 82b or, alternatively, the first drain electrode 66a and the second drain electrode 66b connected to the first subpixel electrode 82a and the second subpixel electrode 82b with the storage wire 28.

The first subpixel electrode 82a and the second subpixel electrode 82b, which form each pixel region, are separated from each other with a predetermined gap therebetween. The outer boundary of the first subpixel electrode 82a and the second subpixel electrode 82b is substantially rectilinear, but alternative exemplary embodiments are not limited thereto. The first subpixel electrode 82a forms the transmissive region, and the second subpixel electrode 82b forms the reflective region, e.g., with the second drain electrode 66b and/or the storage wiring 28 disposed thereunder.

Different gradation voltages may be applied to the first subpixel electrode 82a and the second subpixel electrode 82b to thereby display different images in the transmissive region and the reflective region. However, when the same gradation voltage is applied to the first subpixel electrode 82a and the second subpixel electrode 82b, the main image MAIN IMAGE and the sub image SUB IMAGE may be substantially the same image.

An alignment film (not shown), which aligns the liquid crystal layer 146, is coated on the first subpixel electrode 82a and the second subpixel electrode 82b, as well as the passivation layer 70.

As described above, the LCD 100 according to an exemplary embodiment of the present embodiment separately drives the first subpixel electrode 82a and the second subpixel electrode 82b using the first gate line 22a and the second gate line 22b, and the data line 62. However, alternative exemplary embodiments of the present invention are not limited thereto. For example, the LCD 100 may also drive the first subpixel electrode 82a and the second subpixel electrode 82b separately using one gate line and two data lines. Further, the first TFT may be formed at an intersection of a gate line and a first data line, and the second TFT may be formed at the intersection of the gate line and a second data line. As a result, the first subpixel electrode 82a and the second subpixel electrode 82b are thereby connected to the first TFT and the second TFT, respectively, to separately drive the reflective region and the transmissive region.

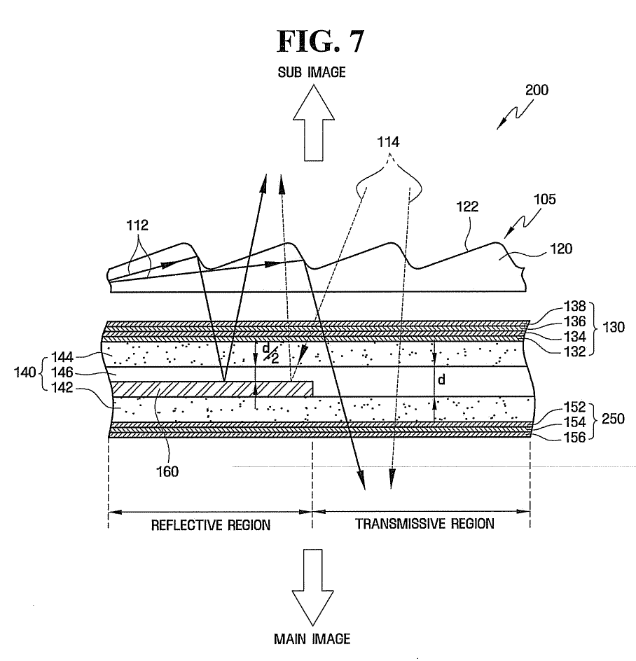

Hereinafter, an LCD according to another exemplary embodiment of the present invention will be described with reference to FIG. 7. FIG. 7 is a partial cross-sectional view of an LCD according to an alternative exemplary embodiment of the present invention. For simplicity, any repetitive description of elements substantially identical to those of the exemplary embodiment described in greater detail above with reference to FIGS. 1 through 6 will hereinafter be omitted.

Referring to FIG. 7, an LCD 200 according to an alternative exemplary embodiment of the present invention includes a first optical film assembly 130. The first optical film assembly 130 includes a first λ/4 phase-difference film 132, a first λ/2 phase-difference film 134, a first polarizing film 136, and a first phase-difference compensating film 138 disposed on an upper surface of a liquid crystal panel 140. In addition, a second optical film assembly 250 includes a second λ/4 phase-difference film 152, a second λ/2 phase-difference film 154, and a second polarizing film 156 disposed on a lower surface of the liquid crystal panel 140. In an exemplary embodiment, light, which passes through the first optical film assembly 130 to form a sub image SUB IMAGE, is circularly polarized, or, in an alternative exemplary embodiment, is elliptically polarized, as described above in greater detail.

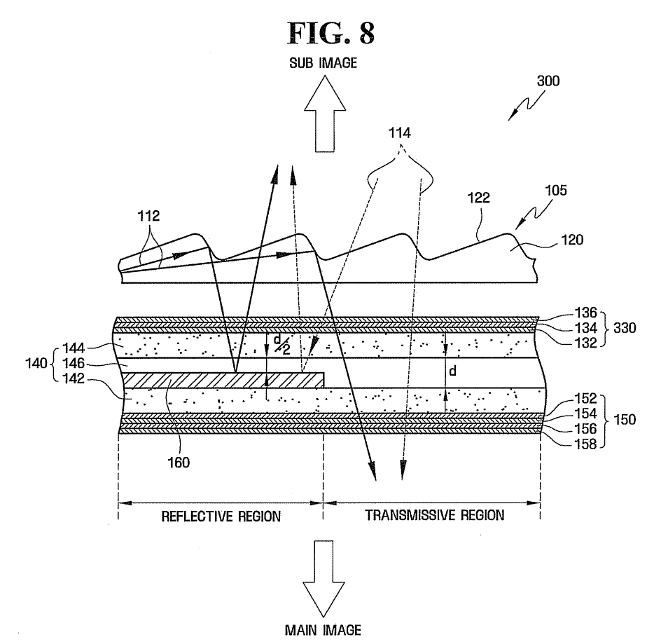

Hereinafter, an LCD according to another exemplary embodiment of the present invention will be described with reference to FIG. 8. FIG. 8 is a partial cross sectional view of an LCD according to another alternative exemplary embodiment of the present invention. For simplicity, any repetitive description of elements substantially identical to those of the exemplary embodiment described in greater detail above with reference to FIGS. 1 through 6 will hereinafter be omitted.

Referring to FIG. 8, an LCD 300 according to an alternative exemplary embodiment of the present invention includes a first optical film assembly 330. The first optical film assembly 330 includes a first λ/4 phase-difference film 132, a first λ/2 phase-difference film 134, and a first polarizing film 136 disposed on an upper surface of a liquid crystal panel 140. In addition, a second optical film assembly 150 includes a second λ/4 phase-difference film 152, a second λ/2 phase-difference film 154, a second polarizing film 156, and a second phase-difference compensating film 158 disposed on a lower surface of the liquid crystal panel 140. Light, which passes through the second optical film assembly 150 to form a main image MAIN IMAGE, is circularly or elliptically polarized, as described above in greater detail.

Thus, according to exemplary embodiments of the present invention as described herein, an LCD provides advantages which include, but are not limited to, having luminance in a specific direction which is not reduced when viewed by a user wearing polarized sunglasses. In addition, different images can be displayed on two surfaces of a liquid crystal panel of the LCD. Further, the LCD is semi-transmissive, and power consumption is thereby substantially reduced and/or effectively minimized.

The present invention should not be construed as being limited to the exemplary embodiments set forth herein. Rather, these exemplary embodiments are provided so that this disclosure will be thorough and complete and will fully convey the concept of the present invention to those skilled in the art.

Further, while the present invention has been particularly shown and described with reference to exemplary embodiments thereof, it will be understood by those of ordinary skill in the art that various changes in form and detail may be made therein without departing from the spirit or scope of the present invention as defined by the following claims.

What is claimed is:

1. A liquid crystal display comprising:
a liquid crystal panel having a reflective region in which a first image is displayed in a first viewing direction and a transmissive region in which a second image is displayed in a second viewing direction different than the first direction;
a first optical film assembly disposed on a first surface of the liquid crystal panel and comprising:
a first phase-difference film which has a first phase difference; and
a first polarizing film; and
a second optical film assembly disposed on a second opposite surface of the liquid crystal panel and comprising:
a second phase-difference film which has a second phase difference; and
a second polarizing film; and
a phase-difference compensating film disposed on at least one of the first polarizing film and the second polarizing film,
wherein the phase-difference compensating film circularly or elliptically polarizes light.

2. The liquid crystal display of claim 1, wherein the phase-difference compensating film has a phase difference of approximately λ/4, λ being a wavelength of the light.

3. The liquid crystal display of claim 1, wherein the first phase-difference film has a phase difference of approximately λ/4.

4. The liquid crystal display of claim 3, further comprising a first λ/2 phase-difference film disposed between the first phase-difference film and the first polarizing film.

5. The liquid crystal display of claim 1, wherein the second phase-difference film has a phase difference of approximately λ/4.

6. The liquid crystal display of claim 5, further comprising a second λ/2 phase-difference film disposed between the second phase-difference film and the second polarizing film.

7. The LCD of claim 1, wherein the liquid crystal panel comprises:
a first display substrate;
a second display substrate facing the first display substrate; and
a liquid crystal layer disposed between the first display substrate and the second display substrate,
wherein when an electric field is applied to the liquid crystal layer, a first portion of the liquid crystal layer which corresponds to the transmissive region has a phase difference of approximately λ/2, and a second portion of the liquid crystal layer which corresponds to the reflective region has a phase difference of approximately λ/4.

8. The liquid crystal display of claim 7, wherein a ratio of a cell gap of the transmissive region to a cell gap of the reflective region is approximately 2:1.

9. The liquid crystal display of claim 7, wherein the first display substrate comprises:
a first gate line and a second gate line disposed in a first direction;
a data line which crosses the first gate line and the second gate line and is disposed in a second opposite direction, the data line being insulated from the first gate line and the second gate line;
a first thin-film transistor formed at an intersection of the first gate line and the data line;
a second thin-film transistor formed at an intersection of the second gate line and the data line;
a first subpixel electrode connected to the first thin-film transistor and formed in the transmissive region; and
a second subpixel electrode connected to the second thin-film transistor and formed in the reflective region,
wherein an output terminal of the second thin-film transistor is formed in the reflective region, the output terminal comprising a material which reflects light.

10. The liquid crystal display of claim 1, further comprising a light guide panel disposed on the first optical film assembly and which guides light supplied to the liquid crystal panel.

11. The liquid crystal display of claim 10, wherein light reflected by the reflective region and light which has passed through the transmissive region passes through the first optical film assembly to form the first image.

12. The liquid crystal display of claim 10, wherein light passed through the transmissive region passes through the second optical film assembly to form the second image.

13. The liquid crystal display of claim 1, wherein the liquid crystal panel comprises:
a first display substrate;
a second display substrate facing the first display substrate; and
a liquid crystal layer disposed between the first display substrate and the second display substrate,
wherein the first display substrate comprises:
a first gate line and a second gate line disposed in a first direction;
a data line which crosses the first gate line and the second gate line and is disposed in a second opposite direction, the data line being insulated from the first gate line and the second gate line;
a first thin-film transistor formed at an intersection of the first gate line and the data line;
a second thin-film transistor formed at an intersection of the second gate line and the data line;
a first subpixel electrode connected to the first thin-film transistor and formed in the transmissive region; and
a second subpixel electrode connected to the second thin-film transistor and formed in the reflective region.

14. The liquid crystal display of claim 13, wherein different data voltages are applied to the first subpixel electrode and the second subpixel electrode.

15. The liquid crystal display of claim 1, wherein the liquid crystal panel comprises:
a first display substrate;
a second display substrate facing the first display substrate; and
a liquid crystal layer disposed between the first display substrate and the second display substrate,
wherein the first display substrate comprises:
a gate line disposed in a first direction;
a first data line and a second data line which cross the gate line, are disposed in a second opposite direction, and are insulated from the gate line;
a first thin-film transistor formed at an intersection of the gate line and the first data line;
a second thin-film transistor formed at an intersection of the gate line and the second data line;
a first subpixel electrode connected to the first thin-film transistor and formed in the transmissive region; and
a second subpixel electrode connected to the second thin-film transistor and formed in the reflective region.

16. The liquid crystal display of claim 1, further comprising a front light unit comprising:
a light guide panel disposed on the first optical film assembly; and
a light source which inputs light to the light guide panel.

17. The liquid crystal display of claim 16, further comprising a reflective layer formed on a portion of a surface of the light guide panel which overlaps the transmissive region of the liquid crystal panel.
